(19) United States
(12) Patent Application Publication
(10) Pub. No.: US 2026/0226263 A1
(43) Pub. Date: Aug. 6, 2026

(54) FOAMABLE RESIN COMPOSITION

(71) Applicants: SUMITOMO CHEMICAL COMPANY, LIMITED, Tokyo (JP); NEWLIGHT TECHNOLOGIES, Inc., Huntington Beach, CA (US)

(72) Inventor: Yuya YAMAMOTO, Ichihara-shi, Chi ba (JP)

(21) Appl. No.: 19/150,335

(22) PCT Filed: Feb. 20, 2024
(86) PCT No.: PCT/JP2024/006115

§ 371 Date: Jul. 23, 2025

(30) Foreign Application Priority Data
Feb. 27, 2023 (JP) 2023-028635

(51) Int. Cl. C08L 23/12; C08J 9/00; C08J 9/10

(52) U.S. Cl. CPC C08L 23/12; C08J 9/0061; C08J 9/103; C08J 2203/04; C08J 2323/12; C08J 2423/08; C08J 2467/04; C08L 2203/14; C08L 2205/025; C08L 2205/03; C08L 2207/02

(57) ABSTRACT

A foamable resin composition containing a propylene-based polymer (A) and a polyhydroxyalkanoate-based polymer (C), in which the foamable resin composition contains 0.1 to 40 parts by mass of the polyhydroxyalkanoate-based polymer (C) with respect to 100 parts by mass of the propylene-based polymer (A), and an isothermal crystallization time of the composition at 135° C. is 450 seconds or more.

### TECHNICAL FIELD

The present invention relates to a foamable resin composition.

### BACKGROUND ART

Conventionally, as shown in Patent Literature 1, a foamed molded body of a thermoplastic resin such as a propylene-based resin is known.

### CITATION LIST

### Patent Literature

Patent Literature 1: Japanese Unexamined Patent Publication No. 2002-234046

### SUMMARY OF INVENTION

### Technical Problem

In the prior art, an appearance defect called a swirl mark may occur on the outer surface of the foamed molded body.

An object of the present invention is to provide a foamable resin composition and the like capable of reducing an appearance defect in a foamed molded body.

### Solution to Problem

[1] A foamable resin composition containing a propylene-based polymer (A) and a polyhydroxyalkanoate-based polymer (C), in which
the foamable resin composition contains 0.1 to 40 parts by mass of the polyhydroxyalkanoate-based polymer (C)
with respect to 100 parts by mass of the propylene-based polymer (A), and
an isothermal crystallization time of the composition at 135° C. is 450 seconds or more.

[2] The foamable resin composition described in [1], in which the propylene-based polymer (A) contains a heterophasic propylene polymerization material.

[3] The foamable resin composition described in [1] or [2], further containing 1 to 40 parts by mass of an ethylene-α olefin copolymer (B) with respect to 100 parts by mass of the propylene-based polymer (A).

[4] A foaming agent-containing resin composition containing the foamable resin composition described in any one of [1] to [3] and a foaming agent.

[5] The foaming agent-containing resin composition described in [4], in which the foaming agent is a physical foaming agent and/or an organic chemical foaming agent.

[6] A foamed molded body obtained by injection-foam molding the foaming agent-containing resin composition described in [4] or [5].

[7] A method for producing a foamed molded body, including a step of injection-foam molding the foaming agent-containing resin composition described in [4] or [5].

### Advantageous Effects of Invention

According to the present invention, there are provided a foamable resin composition and the like capable of reducing an appearance defect in a foamed molded body.

### DESCRIPTION OF EMBODIMENTS

Hereinafter, some embodiments of the present invention will be described in detail. However, the present invention is not limited to the following embodiments.

### (Foamable Resin Composition)

A foamable resin composition according to a first embodiment of the present invention is a foamable resin composition containing a propylene-based polymer (A) and a polyhydroxyalkanoate-based polymer (C), in which the foamable resin composition contains 0.1 to 40 parts by mass of the polyhydroxyalkanoate-based polymer (C) with respect to 100 parts by mass of the propylene-based polymer (A), and an isothermal crystallization time of the composition at 135° C. is 450 seconds or more.

### (Propylene-Based Polymer (A))

A propylene-based polymer is a polymer containing more than 50 mass % of a structural unit derived from propylene, and examples thereof include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer. The propylene-based polymer may be a combination of two or more kinds of propylene-based polymers.

Here, the propylene-based polymer will be described in detail.

As described above, the propylene-based polymer is a polymer containing a propylene unit in an amount of more than 50 mass % when the amount of all constituent units contained in the propylene-based polymer is 100 mass %. The propylene unit may be 60 mass % or more or 70 mass % or more.

Examples of the propylene-based polymer include a propylene homopolymer and a copolymer of propylene and another monomer copolymerizable with propylene. Such a copolymer may be a random copolymer (hereinafter, also referred to as a polypropylene-based random copolymer) or a block copolymer.

The propylene-based polymer may contain one kind of propylene-based polymer alone, or may contain two or more kinds of propylene-based polymers in any combination at any ratio.

Examples of the combination of two or more kinds of propylene-based polymers include a combination of two or more kinds of propylene homopolymers having different weight average molecular weights and the like, and a combination of the following polymer (I) and polymer (II).

The propylene-based polymer may contain a heterophasic propylene polymerization material. Here, the heterophasic propylene polymerization material means a propylene-based polymer (composition) containing the following polymer (I) and polymer (II), in which the polymer (I) and the polymer (II) are not compatible with each other and form different phases. In the propylene-based polymer (A), the ratio of the heterophasic propylene polymer in the propylene-based polymer (A) may be 50 mass % or more, 60 mass % or more, or 70 mass % or more, and may be 80 mass % or 90 mass %.

Here, the polymer (I) is a propylene-based polymer containing a propylene unit in an amount of more than 80 mass % and 100 mass % or less when the amount of all constituent units is 100 mass %. The polymer (I) may be a propylene homopolymer or a copolymer of propylene and another monomer.

Furthermore, the polymer (II) is a propylene-based polymer which is a copolymer of a propylene unit and at least one kind of monomer unit selected from the group consisting of an ethylene unit and an α-olefin unit having 4 or more carbon atoms.

As each of the polymer (I) and the polymer (II), one kind of polymer may be used alone, or two or more kinds of polymers may be used in combination.

From the viewpoint of improving the appearance, the propylene-based polymer is preferably a heterophasic propylene polymerization material.

From the viewpoint of further improving the rigidity of a molded body of a foamable resin composition, the propylene-based polymer has an isotactic pentad fraction (also referred to as a [mmmm] fraction) of preferably 0.97 or more, more preferably 0.98 or more as measured by ¹³C-NMR.

It can be said that the closer the isotactic pentad fraction of the propylene-based polymer is to 1, the higher stereoregularity of a molecular structure of the propylene-based polymer is, and the higher crystallinity of the polypropylene-based polymer is.

When the propylene-based polymer is a copolymer, the isotactic pentad fraction can be measured for a chain of propylene units in the copolymer.

From the viewpoint of further improving molding processability of a foamable resin resin composition, the propylene-based polymer has a melt flow rate (MFR) of preferably 10 g/10 min or more, more preferably 15 g/10 min or more as measured in accordance with JIS K7210 under conditions of 230° C. and a load of 2.16 kgf. The melt flow rate of the polypropylene-based polymer is preferably 250 g/10 min or less and more preferably 200 g/10 min or less. In an aspect, the melt flow rate of the polypropylene-based polymer is preferably 10 g/10 min to 200 g/10 min.

The propylene-based polymer can be produced, for example, by a polymerization method using a polymerization catalyst.

Examples of the polymerization catalyst include a Ziegler type catalyst, a Ziegler-Natta type catalyst, a catalyst containing a compound containing a transition metal element of Group 4 of the periodic table and having a cyclopentadienyl ring and an alkylaluminoxane, a catalyst containing a compound containing a transition metal element of Group 4 of the periodic table and having a cyclopentadienyl ring, a compound that reacts with the compound to form an ionic complex, and an organic aluminum compound, and a catalyst in which a catalyst component (for example, a compound containing a transition metal element of Group 4 of the periodic table and having a cyclopentadienyl ring, a compound that forms an ionic complex, an organic aluminum compound, or the like) is supported on inorganic particles (for example, silica, clay minerals, or the like) and modified.

Furthermore, as the polymerization catalyst, a prepolymerization catalyst prepared by prepolymerizing a monomer such as ethylene or an α-olefin in the presence of the catalyst described above may be used. Examples of the Ziegler-Natta type catalyst include a catalyst in which a titanium-containing solid transition metal component and an organometallic component are combined.

Specific examples of the above polymerization catalyst include conventionally known catalysts described in Japanese Patent Application Laid-Open Publication Nos. S61-218606, H5-194685, H7-216017, H9-316147, H10-212319, and 2004-182981.

Examples of the polymerization method include bulk polymerization, solution polymerization, and gas phase polymerization. Here, the bulk polymerization refers to a method for performing polymerization using a liquid olefin as a medium at a polymerization temperature. The solution polymerization refers to a method for performing polymerization in an inert hydrocarbon solvent such as propane, butane, isobutane, pentane, hexane, heptane, or octane. The gas phase polymerization refers to a method for polymerizing a monomer in a gaseous state in a medium which is the monomer in a gaseous state.

Examples of a method in the above polymerization method (polymerizing method) include a batch method, a continuous method, and a combination thereof. The polymerizing method may be a multistage method performed using a plurality of polymerization reaction tanks connected in series.

As various conditions (polymerization temperature, polymerization pressure, monomer concentration, catalyst putting amount, polymerization time, and the like) in a polymerization step according to the above polymerization method, any suitable conditions can be appropriately determined according to an intended propylene-based polymer.

In producing the propylene-based polymer, in order to remove a residual solvent contained in the propylene-based polymer polymerized by the above polymerization method and an impurity such as an oligomer by-produced in the polymerization step, the propylene-based polymer polymerized by the above polymerization method may be held, for example, at a temperature at which a residual solvent or an impurity such as an oligomer can be volatilized and at a temperature at which the propylene-based polymer cannot be melted, modified, or the like. Examples of such a method for removing an impurity include any conventionally known suitable methods described in Japanese Patent Application Laid-Open Publication No. S55-75410, Japanese Patent No. 2565753, and the like.

Hereinafter, the propylene homopolymer, the propylene-based random copolymer, and the heterophasic propylene polymerization material, each of which serves as the propylene-based polymer, will be described.

### (Propylene Homopolymer)

From the viewpoint of improving the fluidity of the foamable resin composition and the toughness of a molded body of the foamable resin composition, the propylene homopolymer has a limiting viscosity number [η] of preferably 0.1 to 2 dL/g, more preferably 0.5 to 1.9 dL/g, still more preferably 0.7 to 1.8 dL/g.

Furthermore, from the viewpoint of improving the fluidity of the foamable resin composition and the toughness of a molded body of the foamable resin composition, the propylene homopolymer has a molecular weight distribution Mw/Mn of preferably 3 or more and less than 7, more preferably 3 to 5. Here, Mw represents a weight average molecular weight, and Mn represents a number average molecular weight. Note that the molecular weight distribution is a numerical value measured by gel permeation chromatography (GPC).

### (Propylene-Based Random Copolymer)

Examples of the propylene-based random copolymer include a random copolymer containing a propylene unit and an ethylene unit (hereinafter, referred to as a random copolymer (1)), a random copolymer containing a propylene unit and an α-olefin unit having 4 or more carbon atoms (hereinafter, referred to as a random copolymer (2)), and a random copolymer containing a propylene unit, and ethylene unit, and an α-olefin unit having 4 or more carbon atoms (hereinafter, referred to as a random copolymer (3)).

The α-olefin having 4 or more carbon atoms that can constitute the propylene-based random copolymer is preferably an α-olefin having 4 to 10 carbon atoms. Examples of the α-olefin having 4 to 10 carbon atoms include 1-butene, 1-pentene, 1-hexene, 4-methyl-1-pentene, 1-octene, and 1-decene, and 1-butene, 1-hexene, and 1-octene are preferable.

Examples of the random copolymer (2) include a propylene-1-butene random copolymer, a propylene-1-hexene random copolymer, a propylene-1-octene random copolymer, and a propylene-1-decene random copolymer.

Examples of the random copolymer (3) include a propylene-ethylene-1-butene copolymer, a propylene-ethylene-1-hexene copolymer, a propylene-ethylene-1-octene copolymer, and a propylene-ethylene-1-decene copolymer.

The content of the ethylene unit in the random copolymer (1) is preferably 0.1 to 40 mass %, more preferably 0.1 to 30 mass %, and still more preferably 2 to 15 mass %.

The content of the α-olefin unit having 4 or more carbon atoms in the random copolymer (2) is preferably 0.1 to 40 mass %, more preferably 0.1 to 30 mass %, and still more preferably 2 to 15 mass %.

The total content of the ethylene unit and the α-olefin unit having 4 or more carbon atoms in the random copolymer (3) is preferably 0.1 to 40 mass %, more preferably 0.1 to 30 mass %, and still more preferably 2 to 15 mass %.

The content of the propylene unit in each of the random copolymers (1) to (3) is preferably 60 to 99.9 mass %, more preferably 70 to 99.9 mass %, and still more preferably 85 to 98 mass %.

### (Heterophasic Propylene Polymerization Material)

As described above, the polymer (I) that can be contained in the heterophasic propylene polymerization material is a polymer containing a propylene unit in an amount of more than 80 mass % and 100 mass % or less. The total content of the monomer units except the propylene unit in the polymer (I) is usually 0 mass % or more and less than 20 mass %, and may be 0 mass % or 0.01 mass % or more.

Examples of the monomer units except the propylene unit which may be included in the polymer (I) include an ethylene unit and an α-olefin unit having 4 or more carbon atoms.

The α-olefin having 4 or more carbon atoms that can constitute the polymer (I) is preferably an α-olefin having 4 to 10 carbon atoms, more preferably 1-butene, 1-hexene, and 1-octene, and still more preferably 1-butene.

Examples of the polymer (I) include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer.

Among them, the polymer (I) is preferably a propylene homopolymer, a propylene-ethylene copolymer, a propylene-1-butene copolymer, and a propylene-ethylene-1-butene copolymer, and more preferably a propylene homopolymer from the viewpoint of the rigidity of a molded body containing the foamable resin composition.

The molecular weight distribution (Mw/Mn) of the polymer (I) measured by GPC is preferably 3 or more and less than 7 and more preferably 3 to 5.

As described above, the polymer (II) is a copolymer of a propylene unit and at least one kind of monomer unit selected from the group consisting of an ethylene unit and an α-olefin unit having 4 or more carbon atoms.

The total content of the ethylene unit and the α-olefin unit having 4 or more carbon atoms in the polymer (II) is preferably 20 to 80 mass % and more preferably 20 to 60 mass %.

The α-olefin having 4 or more carbon atoms that can constitute the polymer (II) is preferably an α-olefin having 4 to 10 carbon atoms. Examples of the α-olefin that can constitute the polymer (II) include similar examples to the above-described examples of the α-olefin that can constitute the polymer (I).

Examples of the polymer (II) include a propylene-ethylene copolymer, a propylene-ethylene-1-butene copolymer, a propylene-ethylene-1-hexene copolymer, a propylene-ethylene-1-octene copolymer, a propylene-ethylene-1-decene copolymer, a propylene-1-butene copolymer, a propylene-1-hexene copolymer, a propylene-1-octene copolymer, and a propylene-1-decene copolymer, a propylene-ethylene copolymer, a propylene-1-butene copolymer, and a propylene-ethylene-1-butene copolymer are preferable, and a propylene-ethylene copolymer is more preferable.

The content of the polymer (II) in the heterophasic propylene polymerization material is preferably 1 to 50 mass %, more preferably 1 to 40 mass %, still more preferably 5 to 30 mass %, and particularly preferably 8 to 15 mass % when the total content of the polymer (I) and the polymer (II) is 100 mass %.

Examples of the heterophasic propylene polymerization material include a combination of a propylene homopolymer and a (propylene-ethylene) copolymer, a combination of a propylene homopolymer and a (propylene-ethylene-1-butene) copolymer, a combination of a propylene homopolymer and a (propylene-ethylene-1-hexene) copolymer, a combination of a propylene homopolymer and a (propylene-ethylene-1-octene) copolymer, a combination of a propylene homopolymer and a (propylene-1-butene) copolymer, a combination of a propylene homopolymer and a (propylene-1-hexene) copolymer, a combination of a propylene homopolymer and a (propylene-1-octene) copolymer, and a combination of a propylene homopolymer and a (propylene-1-decene) copolymer, in which the polymer (I) is a propylene homopolymer.

Furthermore, other examples of the heterophasic propylene polymerization material include a combination of a (propylene-ethylene) copolymer and a (propylene-ethylene) copolymer, a combination of a (propylene-ethylene) copolymer and a (propylene-ethylene-1-butene) copolymer, a combination of a (propylene-ethylene) copolymer and a (propylene-ethylene-1-hexene) copolymer, a combination of a (propylene-ethylene) copolymer and a (propylene-ethylene-1-octene) copolymer, a combination of a (propylene-ethylene) copolymer and a (propylene-ethylene-1-decene) copolymer, a combination of a (propylene-ethylene) copolymer and a (propylene-1-butene) copolymer, a combination of a (propylene-ethylene) copolymer and a (propylene-1-hexene) copolymer, a combination of a (propylene-ethylene) copolymer and a (propylene-1-octene) copolymer, a combination of a (propylene-ethylene) copolymer and a (propylene-1-decene) copolymer, a combination of a (propylene-1-butene) copolymer and a (propylene-ethylene) copolymer, a combination of a (propylene-1-butene) copolymer and a (propylene-ethylene-1-butene) copolymer, a combination of a (propylene-1-butene) copolymer and a (propylene-ethylene-1-hexene) copolymer, a combination of a (propylene-1-butene) copolymer and a (propylene-ethylene-1-octene) copolymer, a combination of a (propylene-1-butene) copolymer and a (propylene-ethylene-1-decene) copolymer, a combination of a (propylene-1-butene) copolymer and a (propylene-1-butene) copolymer, a combination of a (propylene-1-butene) copolymer and a (propylene-1-hexene) copolymer, a combination of a (propylene-1-butene) copolymer and a (propylene-1-octene) copolymer, a combination of a (propylene-1-butene) copolymer and a (propylene-1-decene) copolymer; a combination of a (propylene-1-hexene) copolymer and a (propylene-1-hexene) copolymer, a combination of a (propylene-1-hexene) copolymer and a (propylene-1-octene) copolymer, a combination of a (propylene-1-hexene) copolymer and a (propylene-1-decene) copolymer, a combination of a (propylene-1-octene) copolymer and a (propylene-1-octene) copolymer, and a combination of a (propylene-1-octene) copolymer and a (propylene-1-decene) copolymer, in which the polymer (I) is a polymer containing a propylene unit and a monomer unit except the propylene unit. Note that, in the examples of the above combination, the polymer (I) is described first, and the polymer (II) is described later.

The heterophasic propylene polymerization material that can be contained in the foamable resin composition is preferably a combination of (a propylene homopolymer and a (propylene-ethylene) copolymer, a combination of a propylene homopolymer and a (propylene-ethylene-1-butene) copolymer, a combination of a (propylene-ethylene) copolymer and a (propylene-ethylene) copolymer, a combination of a (propylene-ethylene) copolymer and a (propylene-ethylene-1-butene) copolymer, and a combination of a (propylene-1-butene) copolymer and a (propylene-1-butene) copolymer, and more preferably a combination of a propylene homopolymer and a (propylene-ethylene) copolymer.

The heterophasic propylene polymerization material can be produced by a production method including a multistage polymerization step including a first polymerization step of generating the polymer (I) and a second polymerization step of generating the polymer (II) in the presence of the polymer (I) generated in the first polymerization step. Polymerization of the heterophasic propylene polymerization material can be performed using the catalyst exemplified as the above-described catalyst that can be used for producing a polypropylene-based polymer.

The limiting viscosity number (hereinafter, referred to as [η]_{I}) of the polymer (I) is preferably 0.1 to 2 dL/g, more preferably 0.5 to 1.5 dL/g, and still more preferably 0.7 to 1.3 dL/g.

The limiting viscosity number (hereinafter, referred to as [η]_{II}) of the polymer (II) is preferably 1 to 10 dL/g, more preferably 2 to 10 dL/g, and still more preferably 5 to 8 dL/g.

Furthermore, a ratio of [η]_{II} to [η]_{I} ([η]_{II}/[η]_{I}) is preferably 1 to 20, more preferably 2 to 10, and still more preferably 2 to 9.

When the polypropylene-based polymer is a heterophasic propylene polymerization material composed of the polymer (I) and the polymer (II) formed by the multistage polymerization step as described above, a part of the polymer (I) generated in the first polymerization step is extracted from a polymerization tank in which the first polymerization step has been performed, the limiting viscosity number thereof is determined, the limiting viscosity number (hereinafter, referred to as [η]_{Total}) of the heterophasic propylene polymerization material finally generated in the second polymerization step is determined, and the limiting viscosity number of the polymer (II) generated in the second polymerization step is calculated using these limiting viscosity numbers and the contents.

Furthermore, when the heterophasic propylene polymerization material composed of the polymer (I) and the polymer (II) is produced by a production method in which the polymer (I) is obtained in the first polymerization step and the polymer (II) is obtained in the second polymerization step, the content of each of the polymer (I) and the polymer (II) and a procedure of measuring and calculating the limiting viscosity numbers ([η]_{Total}, [η]_{I}, and [η]_{II}) are as follows.

From the limiting viscosity number ([η]_{I}) of the polymer (I) obtained in the first polymerization step, the limiting viscosity number ([η]_{Total}) measured by the method described above for the final polymer (that is, the heterophasic propylene polymerization material composed of the polymer (I) and the polymer (II)) obtained in the second polymerization step, and the content of the polymer (II) contained in the final polymer, the limiting viscosity number [η]_{II} of the polymer (II) is calculated by the following formula.

$${[ η ]}_{I I} = ( {[ η ]}_{Total} - {[ η ]}_{I} \times {X}_{I} ) / {X}_{I I} \qquad Formula$$

wherein
[η]_{Total} represents the limiting viscosity number (unit: dL/g) of the final polymer,
[η]_{I} represents the limiting viscosity number (unit: dL/g) of the polymer (I),
X_{I} represents a weight ratio of the polymer (I) to the final polymer, and
X_{II} represents a weight ratio of the polymer (II) to the final polymer.

Note that X_{I} and X_{II} can be determined from a mass balance in the polymerization step.

Here, the weight ratio Xu of the polymer (II) to the final polymer may be calculated by the following formula using the crystal melting heat amount of each of the polymer (I) and the final polymer.

$${X}_{I I} = 1 - {( Δ Hf )}_{T} / {( Δ Hf )}_{P} \qquad Formula$$

wherein
(ΔHf)_{T} represents the melting heat amount (unit: cal/g) of the final polymer (polymer (I) and polymer (II)), and
(ΔHf)_{P} represents the melting heat amount (unit: cal/g) of the polymer (I).

The propylene-based polymer may contain carbon 14 (14C) as a constituent element, or may be obtained by material recycling (mechanical recycling).

The concentration of carbon 14 (14C) contained in the propylene-based polymer is determined as a pMC (percentage of modern carbon: unit %) by an AMS (Accelerator mass spectrometry) method specified in ISO 16620-2:2019.

Since carbon dioxide in the atmosphere contains carbon 14 (14C) at a certain ratio, it is known that plants, for example, corn and trees, which grow by taking in carbon dioxide in the atmosphere contain 14C. Further, it is also known that carbon 14 (14C) is hardly contained in fossil resources such as petroleum considered to have been stored in the ground for a long period of time. Therefore, carbon 14 (14C) can be contained as a constituent element of the propylene-based polymer by using a plant-derived material as a raw material of the monomer used for producing the propylene-based polymer.

In the production of the propylene-based polymer, a fossil resource-derived monomer (such as ethylene, propylene, 1-butene, 1-hexene, or 1-octene), a plant-derived monomer (such as ethylene, propylene, 1-butene, 1-hexene, or 1-octene), chemically recycled monomer (such as ethylene, propylene, 1-butene, 1-hexene, or 1-octene), and the like can be used, and two or more thereof may be used in combination.

Specific examples of the combination of monomers include
fossil resource-derived propylene/plant-derived propylene/chemically recycled propylene,
fossil resource-derived propylene/plant-derived propylene/chemically recycled propylene/fossil resource-derived ethylene/plant-derived ethylene/chemically recycled ethylene,
fossil resource-derived propylene/plant-derived propylene/chemically recycled propylene/fossil resource-derived 1-butene/plant-derived 1-butene/chemically recycled 1-butene,
fossil resource-derived propylene/plant-derived propylene/chemically recycled propylene/fossil resource-derived 1-hexene/plant-derived 1-hexene/chemically recycled 1-hexene, and
fossil resource-derived propylene/plant-derived propylene/chemically recycled propylene/fossil resource-derived 1-octene/plant-derived 1-octene/chemically recycled 1-octene.

The fossil resource-derived monomer is derived from carbon of underground resources such as petroleum, coal, and natural gas, and hardly contains carbon 14 (14C) in general. Examples of a method for producing the fossil resource-derived monomer include a known method such as a method for producing an olefin, for example, by cracking of petroleum-derived naphtha, ethane, or the like, or by dehydrogenation of ethane, propane, or the like.

The plant-derived monomer is derived from carbon circulating as animals or plants on the ground, and generally contains carbon 14 (14C) at a certain ratio. Examples of a method for producing the plant-derived monomer include a known method such as cracking of bionaphtha, a plant oil, an animal oil, or the like, dehydrogenation of biopropane or the like, a method for separating an alcohol from a fermented product of sugar or the like extracted from a plant raw material such as sugar cane and corn, and subjecting the alcohol to a dehydration reaction (Japanese Unexamined Patent Publication Nos. 2010-511634, 2011-506628, 2013-503647, and the like), and a method for subjecting ethylene obtained from plant-derived ethanol, and n-butene to a metathesis reaction (WO2007/055361 and the like).

The chemically recycled monomer is derived from carbon generated through decomposition or combustion of waste, and the content of carbon 14 (14C) varies depending on the waste. Examples of a method for producing the chemically recycled monomer include a known method such as a method for pyrolyzing waste plastic (Japanese Unexamined Patent Publication No. 2017-512246 and the like), a method for cracking waste plant oil, waste animal oil, or the like (Japanese Unexamined Patent Publication No. 2018-522087 and the like), and a method for subjecting waste, such as wet refuse, biomass waste, food waste, waste oil, waste wood, waste paper, and waste plastic, to gasification, alcohol conversion, and a dehydration reaction (Japanese Unexamined Patent Publication No. 2019-167424, WO2021/006245, and the like).

When two or more of a fossil resource-derived olefin, a plant-derived olefin, and a chemically recycled olefin are used, olefins that have each been individually produced may be used by mixing in a combination such as fossil resource-derived olefin/plant-derived olefin, fossil resource-derived olefin/chemically recycled olefin, plant-derived olefin/chemically recycled olefin, and fossil resource-derived olefin/plant-derived olefin/chemically recycled olefin. Furthermore, a mixture produced as any one of the combinations of olefins described above obtained by using, as a raw material or production intermediate in a step of producing an olefin, a mixture in a combination such as fossil resource-derived compound/plant-derived compound, fossil resource-derived compound/chemically recycled compound, plant-derived compound/chemically recycled compound, and fossil resource-derived compound/plant-derived compound/chemically recycled compound, may be used.

As the propylene-based polymer containing carbon 14 (14C), a commercially available propylene-based polymer can be used. Examples thereof include “Bornewables” series manufactured by Borealis A G, “TRUCIRCLE” series manufactured by SABIC, and “CirculenRenew” series manufactured by LyondellBasell Industries.

From the viewpoint of reducing environmental burden, the concentration of carbon 14 (14C) of the propylene-based polymer is preferably 0.2 pMC (%) or more, more preferably 0.5 pMC (%) or more, further preferably 1 pMC (%) or more, further more preferably 5 pMC (%) or more, and particularly preferably 10 pMC (%) or more. From the viewpoint of cost, the concentration thereof is preferably 99 pMC (%) or less, more preferably 95 pMC (%) or less, further preferably 90 pMC (%) or less, further more preferably 70 pMC (%) or less, and particularly preferably 50 pMC (%) or less.

The concentration of carbon 14 (14C) of the propylene-based polymer can be adjusted by changing the ratio of the fossil resource-derived olefins, the plant-derived olefins, and the chemically recycled olefins used in the production of the propylene-based polymer.

### (Ethylene-α-Olefin Copolymer (B))

An ethylene-α-olefin copolymer is a copolymer of ethylene and α-olefin containing more than 50 mass % of a structural unit derived from ethylene. The content of the structural unit derived from ethylene in the ethylene-α-olefin copolymer may be 60 wt % or more, and may be 70 mass % or more.

The ethylene-α-olefin copolymer may be a copolymer having a monomer unit derived from an α-olefin having 3 to 20 carbon atoms and a monomer unit derived from ethylene.

Examples of the α-olefin having 3 to 20 carbon atoms include propylene, 1-butene, isobutene, 1-pentene, 2-methyl-1-butene, 3-methyl-1-butene, 1-hexene, 2-methyl-1-pentene, 3-methyl-1-pentene, 4-methyl-1-pentene, 1-octene, 1-nonene, 1-decene, 1-undecene, and 1-dodecene, and propylene, 1-butene, 1-hexene, or 1-octene is preferable.

Examples of the ethylene-α-olefin copolymer include an ethylene-propylene copolymer, ethylene-1-butene copolymer, ethylene-1-hexene copolymer, an ethylene-1-octene copolymer, and an ethylene-1-butene-1-hexene copolymer. As the ethylene-α-olefin copolymer, only one kind may be used, or two or more kinds may be used in combination. An ethylene-1-butene copolymer or an ethylene-1-octene copolymer is preferable.

### <Polyhydroxyalkanoate-Based Polymer (C)>

The polyhydroxyalkanoate-based polymer is a polyester of hydroxyalkanoic acid. Examples of the hydroxyalkanoic acid include 2-hydroxyalkanoic acid, 3-hydroxyalkanoic acid, and 4-hydroxyalkanoic acid.

Examples of the 2-hydroxyalkanoic acid include glycolic acid, lactic acid, and 2-hydroxybutyric acid. Examples of the polyester of the 2-hydroxyalkanoic acid, that is, poly(2-hydroxyalkanoate)-based polymer include polyglycolic acid and polylactic acid.

Examples of the 3-hydroxyalkanoic acid include 3-hydroxybutyric acid, 3-hydroxypropionic acid, 3-hydroxypentanoic acid, and 3-hydroxyhexanoic acid. The polyester of the 3 hydroxyalkanoic acid, that is, poly(3-hydroxyalkanoate)-based polymer will be described in detail later.

Examples of the 4-hydroxyalkanoic acid include 4-hydroxybutyric acid, 4-hydroxypentanoic acid, and 4-hydroxyhexanoic acid.

The polyhydroxyalkanoate-based polymer (C) may be a homopolymer of a hydroxyalkanoic acid or a polymer of two or more hydroxyalkanoic acids.

The poly(3-hydroxyalkanoate)-based polymer is a polyhydroxyalkanoate, that is, a polyester of a hydroxyalkanoic acid, and necessarily contains a repeating unit of a 3-hydroxyalkanoate represented by formula (1). In formula (1), R is a hydrogen atom, a halogen atom, an alkyl group having 1 to 15 carbon atoms, a cyano group, an amino group having 1 to 18 carbon atoms, an alkoxy group (alkyloxy group) having 1 to 11 carbon atoms, an amide group having 1 to 20 carbon atoms, an aryl group having 6 to 12 carbon atoms, or a monovalent heterocyclic group having 1 to 9 carbon atoms. These groups may have a substituent. In particular, from the viewpoint of compatibility with a component (for example, the propylene-based polymer (A)) except the polyhydroxyalkanoate-based polymer (C) contained in the pellet, R is preferably an alkyl group having 1 to 8 carbon atoms, an amide group having 1 to 20 carbon atoms, or an aryl group having 6 to 8 carbon atoms.

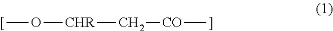

Examples of the halogen atom include F, Cl, Br, and I.

The alkyl group having 1 to 15 carbon atoms may be linear or branched. The number of carbon atoms of the alkyl group is preferably 1 to 8 and more preferably 1 to 4. Examples of the alkyl group include a methyl group, an ethyl group, a propyl group, an isopropyl group, a butyl group, an isobutyl group, a sec-butyl group, a tert-butyl group, a pentyl group, an isopentyl group, a 2-methylbutyl group, a 1-methylbutyl group, a hexyl group, an isohexyl group, a 3-methylpentyl group, a 2-methylpentyl group, a 1-methylpentyl group, a heptyl group, an octyl group, an isooctyl group, a 2-ethylhexyl group, a 3,7-dimethyloctyl group, a nonyl group, a decyl group, an undecyl group, a dodecyl group, a tetradecyl group, and a pentadecyl group.

Examples of the amino group having 1 to 18 or 1 to 11 carbon atoms include an amino group, an alkylamino group, a dialkylamino group, an arylamino group, an alkylarylamino group, a benzylamino group, and a dibenzylamino group.

Examples of the alkylamino group include a methylamino group, an ethylamino group, a propylamino group, a butylamino group, a pentylamino group, a hexylamino group, a heptylamino group, an octylamino group, a nonylamino group, a decylamino group, a dodecylamino group, an isopropylamino group, an isobutylamino group, an isopentylamino group, a sec-butylamino group, a tert-butylamino group, a sec-pentylamino group, a tert-pentylamino group, a tert-octylamino group, a neopentylamino group, a cyclopropylamino group, a cyclobutylamino group, a cyclopentylamino group, a cyclohexylamino group, a cycloheptylamino group, a cyclooctylamino group, a 1-adamantamino group, and a 2-adamantamino group.

Examples of the dialkylamino group include a dimethylamino group, a diethylamino group, a dipropylamino group, a dibutylamino group, a dipentylamino group, a diisopropylamino group, a diisobutylamino group, a diisopentylamino group, a methylethylamino group, a methylpropylamino group, a methylbutylamino group, a methylisobutylamino group, a dicyclopropylamino group, a pyrrolidino group, a piperidino group, and a piperazino group.

Examples of the arylamino group include an anilino group, a 1-naphthylamino group, a 2-naphthylamino group, an o-toluidino group, a m-toluidino group, a p-toluidino group, a 1-fluoreneamino group, a 2-fluoreneamino group, a 2-thiazoleamino group, and a p-terphenylamino group.

Examples of the alkylarylamino group include an N-methylanilino group, an N-ethylanilino group, an N-propylanilino group, an N-butylanilino group, an N-isopropylanilino group, and an N-pentylanilino group.

Examples of the alkoxy group having 1 to 11 carbon atoms include a methoxy group, an ethoxy group, a propoxy group, an isopropoxy group, a butoxy group, an isobutoxy group, a sec-butoxy group, a tert-butoxy group, a cyclopropoxy group, a cyclobutoxy group, and a cyclopentoxy group.

The “amide group” means a group obtained by removing one hydrogen atom bonded to a nitrogen atom from a carboxylic amide. Examples of the amide group having 1 to 20 carbon atoms include a group represented by —NH—C(—O)—R^{A} (provided that, R^{A} is a hydrogen atom or a monovalent organic group) such as a formamide group, an acetamide group, a propionamide group, a butyramide group, a benzamide group, a trifluoroacetamide group, or a pentafluorobenzamide group, and a group represented by —N(—C(═O)—R^{A})(—C(═O)—R^{B}) (provided that, R^{A} and R^{B} are each independently a hydrogen atom or a monovalent organic group) such as a diformamide group, a diacetamide group, a dipropioamide group, a dibutyroamide group, a dibenzamide group, a ditrifluoroacetamide group, or a dipentafluorobenzamide group. The organic group can be an alkyl group, an alkoxy group, or an aryl group which may be substituted with a halogen atom. Among them, the amide group is preferably a formamide group, an acetamide group, a propionamide group, a butyroamide group, or a benzamide group.

Examples of the aryl group having 6 to 12 carbon atoms include a phenyl group, a tolyl group, a xylyl group, a naphthyl group, and a biphenyl group, and among them, a phenyl group, a tolyl group, and a xylyl group are more preferable.

Examples of the heteroatom of the monovalent heterocyclic group having 1 to 9 carbon atoms include N, O, and S, may be saturated or unsaturated, may have a single heteroatom or a plurality of heteroatoms, and may have different types of heteroatoms. Examples of such a heterocyclic group include a thienyl group, a pyrrolyl group, a furyl group, a pyridyl group, a piperidinyl group, a quinolinyl group, an isoquinolinyl group, a pyrimidinyl group, a triazinyl group, and a thiazolyl group.

The repeating unit of the polyhydroxyalkanoate-based polymer (C) may consist only of one or more kinds of 3-hydroxyalkanoate represented by formula (1), and may have one or more kinds of 3-hydroxyalkanoate represented by formula (1) and one or more kinds of other hydroxyalkanoates.

The polyhydroxyalkanoate-based polymer (C) preferably contains 50 mol % or more, more preferably 70 mol % or more, of the repeating unit of 3-hydroxyalkanoate represented by formula (1) with respect to the total repeating unit (100 mol %) of the hydroxyalkanoate.

Examples of the 3-hydroxyalkanoate represented by formula (1) include, when R is a hydrogen atom or an alkyl group represented by CₙH₂ₙ₊₁ and n is an integer of 1 to 15, 3-hydroxybutyrate with n=1 (hereinafter, sometimes referred to as 3HB), 3-hydroxyvalerate with n=2 (hereinafter, sometimes referred to as 3HV), 3-hydroxyhexanoate with n=3 (hereinafter, sometimes referred to as 3HH), 3-hydroxyoctanoate with n=5, 3-hydroxyoctadecanoate with n=15, and 3-hydroxypropionate in which R is a hydrogen atom.

Examples of the polyhydroxyalkanoate-based polymer (C) having only one repeating unit represented by formula (1) include poly(3-hydroxybutyrate) (hereinafter, sometimes referred to as P3HB).

Examples of the polyhydroxyalkanoate-based polymer (C) having only a plurality of repeating units represented by formula (1) include poly(3-hydroxybutyrate-co-3-hydroxyhexanoate) (hereinafter, sometimes referred to as P3HB3HH), poly(3-hydroxybutyrate-co-3-hydroxyvalerate) (hereinafter, sometimes referred to as P3HB3HV), and poly(3-hydroxybutyrate-co-3-hydroxypropionate (hereinafter, sometimes referred to as P3HB3HP).

Examples of the other hydroxyalkanoates except the 3-hydroxyalkanoate represented by formula (1) include a repeating unit represented by formula (2) (wherein R¹ is a hydrogen atom or an alkyl group represented by CₙH₂ₙ₊₁, n is an integer of 1 or more and 15 or less, and m is an integer of 2 to 10).

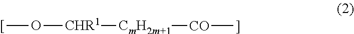

Examples of the polyhydroxyalkanoate-based polymer (C) containing repeating units of formula (1) and formula (2) include poly(3-hydroxybutyrate-co-4-hydroxybutyrate) (for example, the following formula (P3HB4HB)).

From the viewpoint of increasing the melting point, it is preferable that the repeating unit of the polyhydroxyalkanoate-based polymer (C) contains at least 3-hydroxybutyrate among 3-hydroxyalkanoate represented by formula (1).

The polyhydroxyalkanoate-based polymer (C) preferably contains 50 mol % or more, more preferably 70 mol % or more, of the repeating unit of 3-hydroxybutyrate with respect to the total repeating unit (100 mol %) of the hydroxyalkanoate.

The polyhydroxyalkanoate-based polymer (C) may have two or more repeating units of ester, and may be, for example, a di-polymer having two repeating units as described above, a tri-copolymer having three repeating units, and a tetra-copolymer having four repeating units.

Examples of the tri-copolymer include poly(3-hydroxybutyrate-co-3-hydroxyvalerate-co-3-hydroxyhexanoate) (hereinafter, sometimes referred to as (P3HB3HV3HH)).

As described above, the polyhydroxyalkanoate-based polymer (C) preferably contains 3-hydroxybutyrate among the repeating unit of the 3-hydroxyalkanoate represented by formula (1). A ratio XX of the repeating unit of 3-hydroxybutyrate to 100 mol % of the ester repeating unit of the total hydroxyalkanoate is preferably 90 mol % or more, more preferably 95 mol % or more, and still more preferably 98.0 mol % or more.

The ratio XX is usually 100 mol % or less, preferably 99.9 mol % or less, and preferably 99.8 mol % or less.

The form of arrangement of the copolymer may be any form of a random copolymer, an alternating copolymer, a block copolymer, a graft copolymer, and the like.

The polyhydroxyalkanoate-based polymer (C) may have other ester repeating units except those of formula (1) and formula (2), but the main chain of the other ester repeating units does not contain an aromatic hydrocarbon structure. That is, the polyhydroxyalkanoate-based polymer (C) is an aliphatic polyester. However, it is possible that a group having an aromatic hydrocarbon group is bonded to carbon in the main chain of the other ester repeating unit.

As described in L. Tripathi., M. C. Factories, 11, 44 (2012), the composition ratio of the repeating unit in the polyhydroxyalkanoate-based polymer (C) can be determined by calculation from the results of NMR measurement such as 1H-NMR and ¹³C-NMR.

Furthermore, the polyhydroxyalkanoate-based polymer (C) may be a blend of two or more kinds of polyhydroxyalkanoate-based polymers.

The weight average molecular weight (Mw) of the polyhydroxyalkanoate-based polymer (C) can be 10000 to 1000000, and is preferably 20000 to 800000 and more preferably 30000 to 600000. When the weight average molecular weight (Mw) is 10000 or more, a molded body excellent in impact strength and tensile elongation can be obtained. Furthermore, when the weight average molecular weight is 500000 or less, the dispersibility in the propylene-based polymer (A) is improved. The weight average molecular weight may be 400000 or less, 300000 or less, 200000 or less, or 100000 or less. Note that, in the present specification, the weight average molecular weight (Mw) is measured by GPC using standard polystyrene as a molecular weight standard substance.

The polyhydroxyalkanoate-based polymer (C) is a thermoplastic resin, and is suitably crystalline.

The melt mass flow rate (MFR (B)) of the polyhydroxyalkanoate-based polymer (C) as measured according to JIS K7210-2014 under conditions of a temperature of 190° C. and a load of 2.16 kgf is preferably 0.1 g/10 min or more and 200 g/10 min or less. The MFR (B) may be 1 g/10 min or more, 3 g/10 min or more, 5 g/10 min or more, or 7 g/10 min or more. The MFR (B) may be 150 g/10 min or less or 100 g/10 min or less, and may be 70 g/100 min or less, 50 g/100 min or less, 30 g/100 min or less, or 20 g/100 min or less.

The melting point (Tm) of the polyhydroxyalkanoate-based polymer (C) may be 150° C. or higher, 155° C. or higher, 160° C. or higher, 165° C. or higher, 170° C. or higher, or 175° C. or higher. The melting point (Tm) of the polyhydroxyalkanoate-based polymer (C) can be 220° C. or lower, and may be 200° C. or lower or 190° C. or lower.

The melting point (Tm) of the polyhydroxyalkanoate-based polymer (C) is measured by the position of a main peak based on melting of a crystal obtained by differential scanning calorimetry (DSC) measurement in accordance with JIS K7121.

The polyhydroxyalkanoate-based polymer (C) may be produced by microorganisms, and may be derived from a compound (such as a cyclic lactone) derived from a petroleum or plant source.

In the polyhydroxyalkanoate-based polymer (C), each repeating unit of the hydroxyalkanoate may consist of only the D-form (R-form) as in the case of a polymer produced from a microorganism, or the repeating unit of the hydroxyalkanoate may include both the D-form (R-form) and the L-form (S-form) as in the case of a polymer derived from a mixture of the D-form (R-form) and the L-form (S-form).

In a poly(3-hydroxyalkanoate)-based polymer produced from a microorganism, the repeating unit of formula (1) can be expressed as in the following formula. In formula (BI-1), n represents the degree of polymerization.

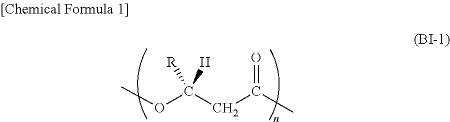

Further, for example, poly-(3-hydroxybutyrate) produced from a microorganism has the structure as described below. In formula (BI-2), n represents the degree of polymerization.

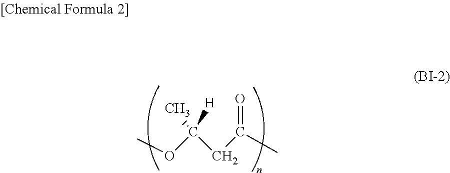

Furthermore, poly-(3-hydroxybutyrate-co-3-hydroxyhexanoate) produced from a microorganism has the structure as described below. In formula (BI-3), m and n represent the degree of polymerization.

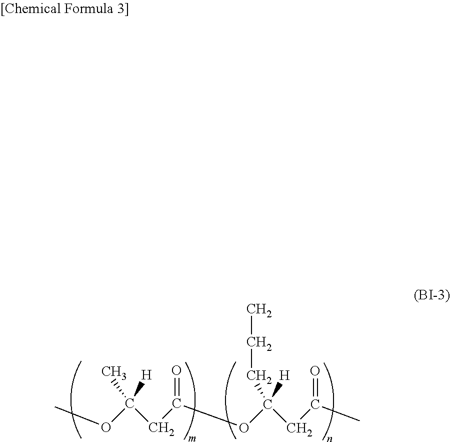

Furthermore, poly-(3-hydroxybutyrate-co-4-hydroxybutyrate) produced from a microorganism has the structure as described below. In formula (BI-4), m and n represent the degree of polymerization.

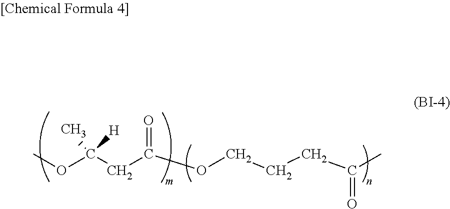

The polyhydroxyalkanoate-based polymer (C) can be biodegradable.

For example, the poly(3-hydroxyalkanoate)-based polymer can be produced by microorganisms such as Alcaligenes eutrophus AC32 strain in which PHA synthase enzyme gene derived from Aeromonascaviae was introduced into Alcaligeneseutrophus (international deposit under the Budapest Treaty, international depositary authority: National Institute of Advanced Industrial Science and Technology Center (Center 6, 1-1-1 Higashi, Tsukuba City, Ibaraki Prefecture, Japan), original deposit date: Aug. 12, 1996, transferred on Aug. 7, 1997, accession number FERMBP-6038 (transferred from original deposit FERMP-15786)) (J. Bacteriol., 179, 4821 (1997)).

### (Additive)

The foamable resin composition may contain an additive as necessary. The additive can be at least one selected from the group consisting of a stabilizer, an anti-bacterial agent, an anti-fungal agent, a dispersing agent, a plasticizer, a flame retardant, a tackifier, a colorant, a metal powder, an organic powder, an organic and inorganic composite fiber, an inorganic whisker, and a filling agent.

Examples of the stabilizer include at least one selected from the group consisting of a lubricant, an anti-aging agent, an antioxidant, a heat stabilizer, a light resistance agent, a weathering agent, a metal deactivator, an ultraviolet absorber, a light stabilizer, and a copper inhibitor. Examples of the light resistance agent include a hindered amine-based light resistance agent.

Examples of the colorant include at least one selected from the group consisting of titanium oxide, carbon black, and an organic pigment. Examples of the metal powder include iron oxide such as ferrite.

Examples of the organic powder include a protein, a polyester (excluding the polyhydroxyalkanoate-based polymer), an aromatic polyamide, cellulose, and vinylon. Examples of the inorganic whisker include potassium titanate whisker.

Examples of the filling agent (filler) include at least one selected from the group consisting of glass powder such as a glass bead, a glass balloon, or a glass flake, silicate mineral, alumina, magnesium oxide, antimony oxide, barium ferrite, strontium ferrite, beryllium oxide, magnesium hydroxide, aluminum hydroxide, basic magnesium carbonate, magnesium carbonate, carbonate mineral, calcium sulfate, magnesium sulfate, basic magnesium sulfate, calcium sulfite, cadmium sulfide, asbestos, mica, calcium carbonate, talc, silica, calcium silicate, hydrotalcite, kaolin, diatomaceous earth, graphite, pumice, ebony powder, cotton flock, cork powder, barium sulfate, fluororesin, cellulose powder, and wood powder.

The shape of the additive when being a particle is not limited, and may be a plate shape, a needle shape, or a fiber shape.

From the viewpoint of the rigidity, impact resistance, and dimensional stability of the pellet and the foamable resin composition, an inorganic additive is preferable, and talc which is a plate-shaped silicate mineral is more preferable.

The foamable resin composition may contain only one of the above additives, and may contain a combination of two or more kinds thereof.

In the foamable resin composition, the additive may be contained in any of the propylene-based polymer (A), the ethylene-α olefin copolymer (B), and the polyhydroxyalkanoate-based polymer (C).

A loss modulus E″ of the foamable resin composition with respect to temperature determined by a dynamic mechanical analysis (DMA) method may have a plurality of peaks (for example, two peaks) in the curve, and preferably one peak (a single peak).

In the DMA method, a measurement sample having a thickness of 0.3 mm and cut into strips is heated stepwise at a heating rate of 2° C./min from a measurement temperature of −150° C. in a measurement mode of tension at a measurement frequency of 5 Hz until the sample is melted and cannot be measured. The strain was in a range of 0.1% or less.

When there is only one peak in the curve, the temperature of the peak corresponds to a glass transition temperature Tg. The glass transition temperature Tg of the foamable resin composition can be −70° C. to 150° C.

### <Composition of Foamable Resin Composition>

The foamable resin composition according to the present embodiment is a composition containing 0.1 to 40 parts by mass of the polyhydroxyalkanoate-based polymer (C) with respect to 100 parts by mass of the propylene-based polymer (A). The foamable resin composition according to the present embodiment may or may not contain the ethylene-α olefin copolymer (B).

The content of the polyhydroxyalkanoate-based polymer (C) may be 0.5 to 35 parts by mass, and is more preferably 1 to 30 parts by mass and still more preferably 3 to 20 parts by mass with respect to 100 parts by mass of the propylene-based polymer (A).

The content of the ethylene-α olefin copolymer (B) may be 1 to 40 parts by mass or 1 to 35 parts by mass, and is preferably 5 to 30 mass.

### (Isothermal Crystallization Time of Foamable Resin Composition)

The isothermal crystallization time of the foamable resin composition of the present embodiment at 135° C. is 450 seconds or more, and may be 470 seconds or more, 480 seconds or more, 490 seconds or more, or 500 seconds or more.

### (Operation)

According to the foamable resin composition according to the present embodiment, the appearance of a foamed molded body is excellent. The reason for this is not clear, but it is considered that when the isothermal crystallization time is long, the crystal growth rate is slow, and the appearance defect during foam molding is reduced.

### (Method for Producing Foamable Resin Composition)

A method for producing the above-described foamable resin composition according to the present embodiment will be described.

This production method includes a step of melting and kneading a propylene-based polymer (A), a necessary amount of an ethylene-α-olefin copolymer (B), a polyhydroxyalkanoate-based polymer (C), and an additive which is added as necessary. The temperature during melting and kneading can be 150 to 250° C. Here, all of the components may be subjected to melt-kneading at a time, or a part of the components may be subjected to the melt-kneading step from the middle. The melt-kneading can be performed by, for example, a twin-screw extruder.

In the present embodiment, the production method may further include a step of extruding the foamable resin composition obtained by melt-kneading from a die to obtain a strand, a step of solidifying the strand, and a step of cutting the solidified strand to obtain a pellet. In another embodiment, the production method includes a step of extruding the foamable resin composition obtained by melt-kneading from a die to obtain a strand and a step of cutting the strand while cooling to obtain a pellet.

The strand may be solidified in contact with water, or the strand may be solidified by contact with a gas such as air on a belt or the like. For a die, a cooling device, and a cutting device, known devices can be used.

### <Method for Producing Foamed Molded Body>

A foamed molded body can be obtained by adding a foaming agent to the above-described foamable resin composition to obtain a foaming agent-containing resin composition, and foam molding the foaming agent-containing resin composition.

The foaming agent is not particularly limited, and a known chemical foaming agent or physical foaming agent can be used. The addition amount of the foaming agent can also be appropriately adjusted according to the foaming rate of a molded body and the like. The foaming agent may be 0.05 to 10 parts by mass, 0.1 parts by mass or more, 0.2 parts by mass or more, or 1.0 part by mass or more, and may be 8 parts by mass or less or 5 parts by mass or less, with respect to 100 parts by mass of the above-described foamable resin composition.

As the chemical foaming agent, an organic compound (organic chemical foaming agent) may be used. From the viewpoint of excellent dispersibility in the polypropylene resin composition, the chemical foaming agent may be preferably a powdery chemical foaming agent.

Examples of the organic compound include polycarboxylic acids such as citric acid, azo compounds such as azodicarbonamide (ADCA), nitroso compounds, hydrazine derivatives, and semicarbazide compounds.

Examples of the polycarboxylic acids include citric acid, oxalic acid, fumaric acid, and phthalic acid. Examples of the azo compounds include azodicarbonamide (ADCA), 1,1′-azobis(1-acetoxy-1-phenylethane), dimethyl-2,2′-azobisbutyrate, dimethyl-2,2′-azobisisobutyrate, 2,2′-azobis(2,4,4-trimethylpentane), 1,1′-azobis(cyclohexane-1-carbonitrile), and 2,2′-azobis[N-(2-carboxyethyl)-2-methyl-propionamidine]. Examples of the nitroso compounds include N,N′-dinitrosopentamethylenetetramine (DPT). Examples of the hydrazine derivatives include 4,4′-oxybis(benzenesulfonylhydrazide) and diphenylsulfone-3,3′-disulfonylhydrazide. Examples of the semicarbazide compounds include p-toluenesulfonyl semicarbazide. Examples of other organic chemical foaming agents include trihydrazinotriazine.

Among these chemical foaming agents, it is preferable to use a foaming agent that does not decompose at a temperature equal to or lower than the melting temperature of (A) a foamable resin composition and decomposes at a temperature equal to or lower than the decomposition temperature of the foamable resin composition. Specifically, azodicarbonamide (ADCA), a nitroso compound, a hydrazine derivative, and a semicarbazide compound are preferable, and from the viewpoint of preventing occurrence of odor and color unevenness of a foamed body, sodium bicarbonate is also preferable.

From the viewpoint of further improving the physical properties and appearance of an injection-foamed molded body, the chemical foaming agent may be preferably a chemical foaming agent that generates a gas of 20 or more and 200 ml/g or less. The amount of gas generated may be adjusted to 20 or more and 200 ml/g or less using a plurality of chemical foaming agents. A method for measuring the amount of gas generated is disclosed in Japanese Unexamined Patent Publication No. 2006-152271.

A chemical foaming agent-containing resin composition can be obtained by melting and kneading a foamable resin composition and a chemical foaming agent using a kneader such as a single-screw extruder, a twin-screw extruder, a Banbury mixer, or a heat roll.

Note that a chemical foaming agent-containing resin composition may be obtained by diluting a chemical foaming agent with a resin to form a masterbatch, and mixing the masterbatch and a foamable resin composition. In this case, the resin preferably contains the propylene-based polymer (A), and also more preferably contains another propylene-based polymer having a melting temperature lower than that of the propylene-based polymer (A) component and a viscosity during melting lower than the viscosity during melting of the propylene-based polymer (A) component. Furthermore, the masterbatch may contain the ethylene-α olefin copolymer (B) and/or the polyhydroxyalkanoate-based polymer (C), and each concentration thereof is not particularly limited, but each concentration thereof may be 10 parts by mass to 80 parts by mass when the total amount of the masterbatch is regarded as 100 parts by mass. The content of the chemical foaming agent in the masterbatch may be 20 to 80 wt %.

The masterbatch is obtained by melt-kneading a chemical foaming agent and a resin using a single-screw or twin-screw extruder, a Banbury mixer, a kneader, or the like.

Examples of the physical foaming agent include inert gases such as nitrogen and carbon dioxide, and volatile organic compounds. Among them, it is preferable to use carbon dioxide, nitrogen, or a mixture thereof in a supercritical state. Two or more kinds of physical foaming agents may be used in combination, and a chemical foaming agent and a physical foaming agent may be used in combination.

In the case of using a physical foaming agent, it is preferable to obtain a physical foaming agent-containing resin composition by mixing a physical foaming agent in a supercritical state with a molten polypropylene-based resin composition. Since the physical foaming agent in the supercritical state has high solubility in a resin and can be uniformly diffused into the molten foamable resin composition in a short time, a foamed molded body having a high expansion ratio and a uniform foamed cell structure can be obtained.

Examples of a step of mixing a physical foaming agent with a molten polypropylene-based resin composition include a step of injecting a physical foaming agent into a nozzle or a cylinder of an injection molding apparatus.

Specific examples of the method for foam molding the foaming agent-containing resin composition include known methods such as an injection-foam molding method, a press-foam molding method, an extrusion-foam molding method, and a stampable-foam molding method. From the viewpoint of obtaining a foamed molded body excellent in appearance, it is also preferable to adopt a molding method of changing mold clearance after injection described in Japanese Unexamined Patent Publication No. 2002-225165.

The foamed molded body of the present invention can also be formed into a decorative foamed molded body by bonding a skin material by a method such as insert molding or adhesion.

As the skin material, a known skin material can be used. Specific examples of the skin material include a woven fabric, a nonwoven fabric, a knitted fabric, and a film and sheet made of a thermoplastic resin or a thermoplastic elastomer. Further, a composite skin material obtained by laminating a sheet of polyurethane, rubber, thermoplastic elastomer, or the like on these skin materials may be used.

A cushion layer can be further provided on the skin material. Examples of a material constituting such a cushion layer include a polyurethane foam, an EVA (ethylene-vinyl acetate copolymer) foam, a polypropylene foam, and a polyethylene foam.

### <Use Application of Foamed Molded Body>

Examples of the use application of the foamed molded body according to the present invention include automotive materials, household electric appliance materials, OA device materials, building materials, drainage equipment, toilet materials, various tanks, containers, and sheets.

Examples of the automotive materials include interior components such as door trims, pillars, instrument panels, consoles, locker panels, arm rests, door inner panels, and spare tire covers, exterior components such as bumpers, spoilers, fenders, side steps, and door outer panels, other components such as air-intake ducts, coolant reserve tanks, radiator reserve tanks, window washer tanks, fender liners, and fans, and integrally molded components such as front end panels.

Examples of the household electric appliance materials include washing machine materials (such as an outer tank, an inner tank, a lid, a pulsator, a balancer, and a washing pan), drying machine materials (such as an exterior, an inner box, and a lid), vacuum cleaner materials, rice cooker materials, electric pot materials, heat insulator materials, dish washer materials, and air cleaner materials.

Examples of the OA device/media-related materials include cases of a magnetic recording medium or an optical recording medium, personal computer components, and printer components.

Examples of the building materials include frames for hardening concrete and the like, and wall members. Examples of the drainage equipment include pipes and pump parts. Examples of the container materials include food filling containers, transport containers, and clothes containers. Furthermore, transportation pallets and the like are exemplified.

Among them, the use applications of the molded article of the present invention are preferably automotive materials, household electric appliance materials, building materials, drainage equipment, containers, and transportation pallets.

### EXAMPLES

Hereinafter, the present invention will be specifically described with reference to Examples. However, the present invention is not limited to Examples described below.

### Components Used in Examples and Comparative Examples

The components used in Examples and Comparative Examples are shown below.

### (Propylene-Based Polymer (A))

### (Propylene-Based Polymer (A-1): Heterophasic Propylene Polymerization Material)

A heterophasic propylene polymerization material (A-1) as a propylene-based polymer was produced by a liquid-gas phase polymerization method using a polymerization catalyst obtained by the method described in Example 1 of Japanese Unexamined Patent Publication No. 2004-182981. The physical properties were as follows.
Melt flow rate (230° C., 21.18 N load): 90 g/10 min
Propylene homopolymer component
Limiting viscosity number: 0.79 dL/g
Ethylene-propylene random copolymer component
Limiting viscosity number: 7.0 dL/g
Content of structural unit derived from ethylene: 32 mass %

### (2) Ethylene-α-Olefin Copolymer (B)

### (B-1) Ethylene-Butene Random Copolymer

Manufactured by Sumitomo Chemical Co., Ltd.: Excellen FX555
Density: 0.870 (g/cm³)
MFR (190° C., 21.18 N load): 16 g/10 min Content of structural unit derived from butene: 24 mass %

### (3) (Polyhydroxyalkanoate-Based Polymer (C))

Manufactured by Newlight Technologies: poly(3-hydroxybutyrate)
   Melt flow rate (190° C., 21.18 N load): 1.8 g/10 min

### (4) Component (D) Foaming Agent

(D-1) Azodicarbonamide was used. “Trade name: MB-31” manufactured by Sankyo Kasei Co., Ltd.

### Examples 1 and 2 and Comparative Examples 1 and 2

A propylene-based resin composition was produced by the following method.

As raw materials and an additive having the composition in Table 1, 0.05 parts by weight of “calcium stearate (manufactured by Sakai Chemical Industry Co., Ltd.)”, 0.05 parts by weight of “SUMILIZER GA80 (manufactured by Sumitomo Chemical Co., Ltd.)”, and “SONGNOX 6260 (manufactured by SONGWON)” were mixed, and then fed into a twin-screw kneader KZW-15/45 MG (cylinder diameter: 15.5 mm, screw diameter: 15.0 mm, L/D=45) manufactured by TECHNOVEL CORPORATION, and melt-kneaded to obtain a pellet-shaped propylene-based resin composition. The melt-kneading conditions are as follows.

Cylinder temperature: 230° C.; screw rotation speed: 300 rpm; two screen meshes of 100 mesh and 50 mesh are stacked.

The evaluation results of the obtained propylene-based resin composition are shown in Table 1. Furthermore, a foamed molded body was prepared using the obtained resin composition, and the appearance was evaluated. The results are shown in Table 1, and the details of the evaluation method are shown after Table 1. Note that, in Example 1, with respect to 100 parts by mass of propylene-based polymer A-1, the amount of ethylene-α-olefin copolymer B-1 was 0 parts by mass, and the amount of polyhydroxyalkanoate C-1 was 5.3 parts by mass, and in Example 2, with respect to 100 parts by mass of propylene-based polymer A-1, the amount of ethylene-α-olefin copolymer B-1 was 28.2 parts by mass, and the amount of polyhydroxyalkanoate C-1 was 12.7 parts by mass.

TABLE 1

| | | | |
|---|---|---|---|
| | | Comparative | Comparative |
| Example 1 | Example 2 | Example 1 | Example 2 |

Propylene-based resin composition (foamable resin composition)

| | | | | | |
|---|---|---|---|---|---|
| Polypropylene- | A-1 | 95 | 71 | 100 | 80 |
| based polymer | | | | | |
| (parts by mass) | | | | | |
| Ethylene-α-olefin | B-1 | | 20 | | 20 |
| copolymer | | | | | |
| (parts by mass) | | | | | |
| Polyhydroxyalkanoate | C-1 | 5 | 9 | | |
| (parts by mass) | | | | | |
| Isothermal | | 561 | 504 | 435 | 286 |
| crystallization | | | | | |
| time (sec) | | | | | |
| MFR (g/10 min) | | 149 | 129 | 87 | 92 |

Foamed molded body

| | | | | | |
|---|---|---|---|---|---|
| Foaming agent | D-1 | 2 | 2 | 2 | 2 |
| (parts by weight) | | | | | |
| Appearance | | ∘ | ∘ | x | x |
| (swirl mark) | | | | | |

### Evaluation Methods

1. Isothermal Crystallization Time (Crystallization Time, T_{1/2}, Unit: sec)

It was measured using a differential scanning calorimeter (DSC VII type manufactured by PerkinElmer). The measurement conditions were as follows: 10 mg of a specimen was placed in a nitrogen atmosphere in advance, isothermal crystallization was performed for 10 minutes under the condition of a crystallization temperature of 135° C., and the half width of the peak of the obtained endothermic curve was measured as the isothermal crystallization time.

2. Melt Flow Rate (MFR) (Unit: g/10 min)

It was measured at a temperature of 230° C. and a load of 2.16 kgf according to the method specified in JIS K7210.

### 3. Evaluation of Appearance (Swirl Mark)

A foaming agent (D) in an addition amount described in Table 1 was mixed with the propylene-based resin composition of each of Examples and Comparative Examples, and the mixture was supplied to “SE130 type molding machine” manufactured by Sumitomo Heavy Industries, Ltd., and a flat plate having a length of 150 mm, a width of 90 mm, and a thickness of 2.0 mm was molded at a molding temperature of 190° C., a mold cooling temperature of 50° C., a pressure of 50 MPa, an injection speed of 100 mm/see, a pressure holding of 40 MPa, and a pressure holding time of 4 seconds. The formed flat plate surface was visually evaluated and determined as follows.

∘: The swirl mark on the surface of the foamed body cannot be visually confirmed.

Δ: The swirl mark is slightly noticeable.

x: The swirl mark is noticeable.

1. A foamable resin composition comprising:
a propylene-based polymer (A); and
a polyhydroxyalkanoate-based polymer (C), wherein
the foamable resin composition contains 0.1 to 40 parts by mass of the polyhydroxyalkanoate-based polymer (C) with respect to 100 parts by mass of the propylene-based polymer (A), and
an isothermal crystallization time of the composition at 135° C. is 450 seconds or more.

2. The foamable resin composition according to claim 1, wherein the propylene-based polymer (A) contains a heterophasic propylene polymerization material.

3. The foamable resin composition according to claim 1, further comprising 1 to 40 parts by mass of an ethylene-α olefin copolymer (B) with respect to 100 parts by mass of the propylene-based polymer (A).

4. A foaming agent-containing resin composition comprising:
the foamable resin composition according to claim 1; and
a foaming agent.

5. The foaming agent-containing resin composition according to claim 4, wherein the foaming agent is a physical foaming agent and/or an organic chemical foaming agent.

6. A foamed molded body obtained by injection-foam molding the foaming agent-containing resin composition according to claim 4.

7. A method for producing a foamed molded body, comprising:
a step of injection-foam molding the foaming agent-containing resin composition according to claim 4.
